(19) United States
(12) Patent Application Publication
(10) Pub. No.: US 2026/0046230 A1
(43) Pub. Date: Feb. 12, 2026

(54) MEASURING PERFORMANCE OF REDUNDANT NETWORKS IN REAL-TIME

(71) Applicant: Cisco Technology, Inc., San Jose, CA (US)

(72) Inventors: Priyanka Bansal, Bangalore (IN); Srinivasa Roa Nalluri, Bangalore (IN); Robert Edgar Barton, Richmond (CA); Albert Hyde Mitchell, San Jose, CA (US)

(21) Appl. No.: 18/796,820

(22) Filed: Aug. 7, 2024

(51) Int. Cl. H04L 43/0852; H04L 43/0829; H04L 43/106; H04L 45/02

(52) U.S. Cl. CPC H04L 43/0858; H04L 43/0835; H04L 43/106; H04L 45/04

(57) ABSTRACT

Techniques for measuring performance between two networks are described. A first link redundancy entity (LRE) transmits a first instance of a packet to a second LRE via a first network and a second instances of the packet to the second LRE via a second network. The first instance of the packet and the second instance of the packet have a timestamp indicating a time when the first LRE transmitted the packets. The second LRE records a first arrival time for the first instance of the packet and a second arrival time for the second instance of the packet. The second LRE determines a first latency for the first instance of the packet and a second latency for the second instance of the packet. Based at least in part of the first latency and the second latency, the second LRE determines a performance difference between the first and second networks.

### TECHNICAL FIELD

The present disclosure relates generally to measuring network performance in redundant local area networks (LANs) in real time by analyzing metadata available on the received Ethernet frames.

### BACKGROUND

In today's networking environment, high-availability networks for critical systems are a must. A common way to approach the need for high-availability networks is through network redundancy. Network redundancy is the process of providing multiple paths for traffic so that data can keep flowing even in the event of a failure. By implementing redundant networks, enterprises can reduce the risk of data loss, unauthorized access, and service outages. One of the main advantages of network redundancy is continuous availability. That is if one device fails, another can automatically take over without interrupting data traffic. Essentially, the probability that a failure will take down a network is significantly reduced.

High-availability Seamless Redundancy (HSR) and Parallel Redundancy Protocol (PRP) are popular network redundancy mechanisms that provide a zero-loss, zero-delay recovery in case of single failure using the concept of redundancy over two different Local Area Networks (LANs), LAN A and LAN B. HSR and PRP are protocols designed to provide seamless failover against faults in Ethernet networks. Even in the event of link failures, no packets will be lost. For example, under PRP each node is connected to two separate, parallel LANs, LAN A and LAN B. A source node sends two copies of each packet, each with a same sequence number, one over LAN A and one over LAN B. When a destination node receives a packet, it accepts the first copy with sequence number and eliminates the second copy by discarding it. Since the two LANs are assumed to be fail-independent, the destination node will receive at least one packet as long as either one of the networks is operational. With HSR, the most commonly used topology is a ring network based on one physical LAN or two interconnected LANs. Like PRP, a source node sends two copies of each packet, with a same sequence number, to a destination node using two different paths. Thus, one frame can arrive several times, but the first fame with the sequence number one is accepted, the others are discarded. HSR and PRP are most commonly used in systems where high availability is crucial, such as in industrial systems, power plants, or substation automation.

The performance of different LANs in general can be influenced by many factors, including but not limited to the type of hardware used (switches, hubs, etc.), the type of cabling and the distance between devices, the network configuration, and the amount of network traffic. Currently, there are multiple tools available for network performance measurement. For example, Wireshark, Ping, Traceroute, NETSCOUT, and SolarWinds Network Performance Monitor to name a few. However, when using HSR/PRP these tools cannot directly measure individual LAN performance, as duplicate packets and LAN segments are involved. To utilize these existing tools to measure individual performances of both networks, LAN A or LAN B are manually shut down one at a time. Unfortunately, this approach does not correctly review performance of a bi-casting network topology such as PRP or HSR.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment that may implement various aspects of the technologies directed to measuring relative network performance in redundant networks in real time by analyzing metadata available in the received packets.

FIG. 2 illustrates a flow diagram example input(s) and output(s) of an analytics tool.

FIG. 3 is a flow diagram illustrating an example method associated with the techniques described herein measuring relative network performance in redundant networks in real time.

FIG. 4 illustrates a block diagram illustrating an example packet switching system that can be utilized to implement various aspects of the technologies disclosed herein.

FIG. 5 illustrates a block diagram illustrating certain components of an example node that can be utilized to implement various aspects of the technologies disclosed herein.

FIG. 6 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes a method that includes determining, receiving, from a first link redundancy entity (LRE) and by a second LRE, a first instance of a packet and a second instance of the packet, the first instance of the packet having a timestamp and transmitted via a first network, the second instance of the packet having the timestamp and transmitted via a second network, wherein the timestamp indicates a time when the first LRE transmitted the first instance of the packet and the second instance of the packet. The method may also include recording, by the second LRE, a first arrival time for the first instance of the packet. The method may also include recording, by the second LRE, a second arrival time for the second instance of the packet. The method may also include determining, by the second LRE, a first latency for the first instance of the packet. The method may also include, determining by the second LRE, a second latency for the second instance of the packet. Finally, based at least in part on the first latency and the second latency, the method may include determining, by the second LRE, a performance difference between the first network and the second network.

Additionally, the techniques described herein may be performed by a system and/or device having non-transitory computer-readable media storing computer-executable instructions that, when executed by one or more processors, performs the method described above.

### EXAMPLE EMBODIMENTS

Being able to characterize the performance of LAN A and LAN B in HSR/PRP networks is crucial for several reasons. For example, measuring performance helps ensure that the LANs can reliably handle the demands placed upon them, even in the event of a fault. In addition, with HSR/PRP, it is crucial to confirm that the redundancy is functioning as expected. Measuring performance can help verify that both LAN A and LAN B are effectively handling traffic and that failover occurs seamlessly if either LAN A or LAN B experience a fault. Typically, redundant networks will operate independently of one another, and each will be used for other functions. When a redundant networking system continue to function, a network operator may not be aware of the differences in the functioning of each network and may not realize that that a difference between the two exists, perhaps even a crucial difference. Essentially the performance of the individual networks is unknown, and if one network is performing significantly worse than the other, or degraded significantly more than the other, a single failure in one of the networks could lead to a loss of communication. By understanding the performance characteristics of LAN A and LAN B, network administrators cannot only prevent this scenario where a large delta in performance between the networks exists, but also plan for future growth and expansion, which might involve upgrading hardware, increasing bandwidth, or adjusting the network architecture. Also, performance measurements can identify bottlenecks or inefficiencies in a network. This information can then be used to optimize the network for better performance and further ensure that should one network fail unexpectedly, the other is equipped to handle the traffic. Another crucial reason for being able to characterize the performance of LAN A and LAN B in an HSR/PRP network is for validation of Service Level Agreements (SLAs). If there are SLAs with customers or internal stakeholders, performance measurement and monitoring is a must to ensure the SLA commitments are met. Additionally, when problems do arise, having baseline performance measurements can help identify the cause of issues and guide corrective actions. Moreover, monitoring network performance can also help identify unusual traffic patterns or spikes that might indicate a security threat. Finally, in some cases, regular performance monitoring and reporting might be required for compliance with industry regulations or standards. However, as mentioned above, the multiple tools that are currently available for individual network performance measurement and monitoring, require manually shutting either LAN A or LAN B down one at a time. This approach negates the advantages that are provided by redundant networks, as well as consuming excessive resources, including both monetary and temporal resources.

This disclosure is directed to techniques for measuring network performance in redundant networks in real time by analyzing metadata available on the received packet pairs. Performance characteristics in High-availability Seamless Redundancy/Parallel Redundancy Protocol (HSR/PRP) networks between LAN A and LAN B involve assessing throughput, latency, jitter, packet loss, and availability through techniques like packet capture, network monitoring, and end-to-end testing. There is no need to send or process any extra control traffic, and no need to shut down either LAN A or LAN B at any time as required by conventional means. PRP frames carry a redundancy control trailer (RCT) which contains a 16-bit sequence number for each packet pair. Similarly, HSR frames carry an HSR tag containing a sequence number for each frame. Techniques described herein are utilized to calculate current performance metrics of LAN A and LAN B using the arrival time of frames on both LANs using an embedded timestamp along with sequence numbers in the RCT trailer for PRP and the HSR tag for HSR. This data is collected over a period of time to derive useful insights about varying performance metrics of LAN A and LAN B in HSR/PRP networks. LAN A and LAN B in HSR/PRP networks are meant to be exemplary and not limiting. The techniques described herein may apply to any appropriate type of redundant network architecture.

To implement techniques for measuring network performance in redundant networks described herein, in HSR/PRP networks a transmitting Link Redundancy Entity (LRE) will replicate the frame on both LAN A and LAN B. In some instances, a new timestamp is embedded in the PRP header or HSR tag along with the sequence number of a packet pair. Alternately, in other instances no timestamp is added. If no timestamp is added, on a receiving LRE, packet arrival times, one for each frame, a first instance received via LAN A and a second instance received via LAN B, are recorded based on frame arrival time, and used to calculate relative latency. By measuring a time difference of arrival over both links, the receiving LRE can calculate performance differences between the two LAN segments. Alternately or in addition, the receiving LRE may examine a timestamp embedded in an HSR tag or PRP trailer to calculate absolute latency for each network. Note, it is expected that the transmitting LRE and receiving LRE will have time sync using a protocol such as IEEE 1588 PTP. The receiving LRE collects data on the frame pairs for each sequence number in a time series. In the event that duplicate sequence numbers are not detected over a period of time (e.g., within a predetermined amount of time), the receiving LRE counts the second frame as lost. Thus, the receiving LRE can accumulates metrics for frame loss for both LAN A and LAN B.

Data collected by the receiving LRE may then be fed to an analytics tool to derive additional useful insights related to the performance of LAN A and LAN B in HSR/PRP networks. The analytics tool may be a cloud-based service, on-prem at a customer, or localized inside the receiving LRE itself as an edge application. Using the data collected by the receiving LRE along with other network telemetry data, the analytics tool may derive insights for LAN A and LAN B such as bandwidth, or the difference in the capacity of LAN A versus LAN B to transfer data. In addition, the analytics tool can determine the amount of data flowing through LAN A and LAN B at a given time, as well as localized traffic conditions per LAN. If bandwidth and network traffic is constant, the analytics tool may determine the quality and capabilities of network devices such as switches, network interface cards, network cables, connectors, etc. Furthermore, the analytics tool may determine the lossy nature of the LANs, or the difference in packet loss between LAN A and LAN B for a given time duration. Also, if bandwidth and network traffic are constant, the efficiency of the software running on network devices of each LAN may be determined. Additionally, differences in quality of service (Qos) settings may be determined as the insertion of firewalls, antivirus software, and other security measures can slow down a network.

By using the data set described above (bandwidth, network traffic, network hardware differences, lossy nature of the networks, software differences, and insertion of security measures) along with the time-series performance data collected for packet pairs by the receiving LRE and described herein, the analytics tool can predict network performance for both LAN A and LAN B. The analytics tool may be a machine learning (ML) model and using the above data as inputs, the system may train the model to predict which LAN segment is likely to be dominant under certain network conditions. The ML model may also predict what the expected latency of frames will be on a given LAN segment. For example, in a scenario where one of the LAN segments is so slow that packets transmitted via the LAN segment do not arrive until a predetermined time period in which the receiving LRE watches for duplicate frames has expired, and the receiving LRE has considered them lost. In this scenario, PRP is essentially useless, as the redundant network is reduced to only using one of the networks. Thus, if the network in use fails, there is no backup. By implementing techniques described herein to measure the variation of performance metrics between the two side of the HSR/PRP LANs, necessary network changes may be preemptively planned as well as unexpected network problems diagnosed.

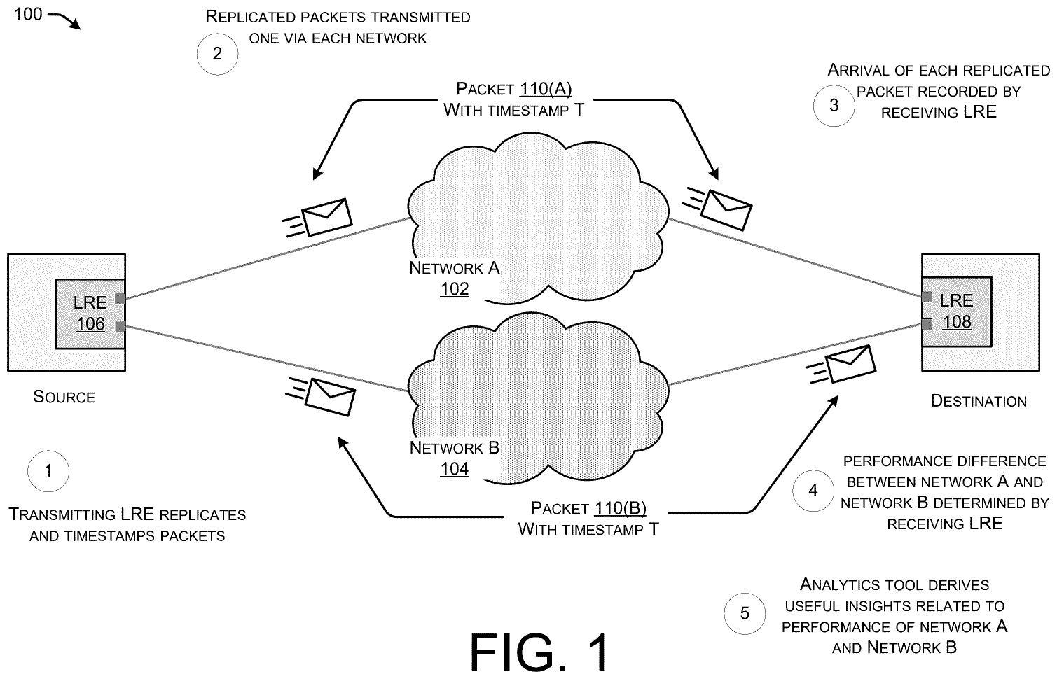

FIG. 1 illustrates an example environment 100 that may implement various aspects of the technologies directed to measuring network performance in redundant networks in real time by analyzing metadata available in the received packets. Environment 100 includes two redundant networks, network A 102 and network B 104. Network A 102 and Network B 104 may be LANs that include various network devices such as switches, routers, firewalls, access points, etc. Alternately, network A 102 and network B 104 may be Wide Area Networks (WANs) or any other appropriate type of network that connects devices together and is used for transmitting and receiving information between a source and a destination. In some examples network A 102 and network B 104 may have identical configurations, and in other instances they may be configured differently. Example environment 100 also includes a source and a destination that utilize the redundant networks, network A 102 and network B 104, for communicating to ensure zero-loss and zero-delay communication. As an example, in environment 100 the source is Link Redundancy Entity (LRE) 106 and the destination is LRE 108. LRE 106 and LRE 108 may be doubly attached nodes with two interfaces, one interface that attaches to network A 102 and the other interface that attaches to network B 104. Similarly, in example environment 100, LRE 108 has two interfaces, one interface that attached to network A 102 and a second interface that attaches to network B 104. Alternately or in addition, an environment that facilitates techniques described herein may include additional and/or different devices, for example, singly attached nodes, virtual doubly attached nodes, redundancy boxes, and the like. LRE 106 and LRE 108 are an example source and destination devices and not meant to be limiting, any other appropriate device(s) that may be used with redundant networks may be a source or destination device for the techniques described herein. Environment 100 also includes two instances of a packet 110 sent from the source to the destination. The source LRE 106 replicates the packet and transmits the first instance of the packet, packet 110(A), over network A 102, and transmits the second instance of the packet, packet 110(B), over network B 104, to LRE 108, the destination.

In some examples, when transmitting LRE 106 replicates packet 110, a timestamp is embedded as metadata in packet 110(A) and packet 110(B). The timestamp T, illustrated in environment 100 indicates a time when both packet 110(A) and packet 110(B) are transmitted from LRE 106 via their respective networks to the destination. For example, in timestamp T may be embed in a RCT trailer of a PRP frame along with a sequence number, or in an HSR tag along with the sequence number in an HSR frame. In other examples, a timestamp may not be embedded in the packet pair.

To implement techniques described herein for measuring network performance for redundant networks at (1) a source node, the transmitting link redundancy entity (LRE), LRE 106, replicates a packet 110 and embeds a timestamp T as metadata in the replicated packets, packet 110(A) and packet 110(B). In addition, the packet pair has a sequence number identifying each packet as a replicate of the same packet. The timestamp T indicates a time when LRE 106 transmits packet 110(A) and packet 110(B) to a destination. Additionally, packet 110(A) and packet 110(B) contain a sequence number indicating that they are replicates of a same packet. For example, timestamp T may be embedded in a RCT trailer of a PRP frame of an HSR tag of an HSR frame. Alternately, in some instances, LRE 106 does not add a timestamp to packet 110(A) and packet 110(B). Once the packet 110 is replicated, at (2) the transmitting LRE 106 transmits the replicated packets to the destination via redundant networks. As indicated in environment 100, LRE 106 transmits the first instance of the packet, packet 110(A) over network A 102, and transmits the second instance of the packet, packet 110(B) over network B 104. At (3) the destination, or receiving LRE, LRE 108, records an arrival time of packet 110(A) and an arrival time of packet 110(B). If a first instance (or a second instance) of packet 110 is not received by LRE 108 within a predetermined amount of time of a second instance (or first instance) of the packet 110, LRE 108 may determine that the first instance of the packet (or second instance) is lost. As shown is example environment 100, packet 110(B) arrives at LRE 108 before packet 110(A). Thus, the recorded arrival time of packet 110(B) will be prior to the recorded arrival time of packet 110(A). In some examples, when there is no embedded timestamp in the metadata of packet 110(A) and packet 110(B), LRE 108 can note the arrival time of each packet 110 having a same sequence number, and by measuring the time difference of arrival over both network A 102 and network B 104, LRE 108 can calculate a point-in-time performance difference between network A 102 and network B 104. Alternately, in examples where packet 110(A) and packet 110(B) do have timestamp T embedded in their metadata, receiving LRE 108 may use the timestamp T and the recorded arrival time of packet 110(A) and packet 110(B) to calculate an absolute latency for network A 102 and network B 104 as indicated at (4). Thus, LRE 108 collects data (e.g., latency, loss, etc.) on the packet pairs for each sequence number in a time series. At (5) the data collected on the packet pairs by LRE 108 may be sent to an analytics tool to further derive useful insights related to the performance of network A 102 and network B 104. The analytics tool may be a cloud-based service, on-prem at a customer, or localized inside the receiving LRE 108 itself as an edge application. Using the data collected by the receiving LRE 108 along with other network telemetry data, the analytics tool can begin predicting network performance for both network A 102 and network B 104. For examples, an ML model analytics tool may predict which network is likely to be dominant under certain network conditions, of even the expected latency of frames on a given network.

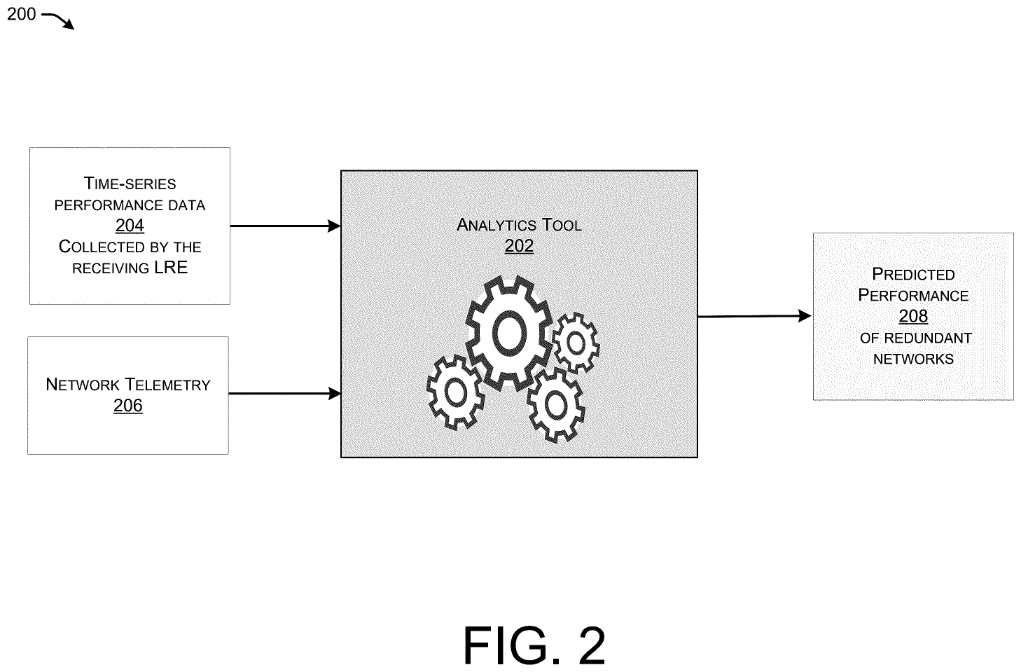

FIG. 2 illustrates a flow diagram 200 of example inputs(s) and output(s) of the analytics tool used to derive useful insights related to the performance of redundant networks. As illustrated, the analytics tool 202 may receive time series performance data 204 collected by a receiving LRE as well as other network telemetry 206 for each network in a redundant HSR/PRP networks as inputs. In some examples, the analytics tool 202 may be a pre-trained model (e.g., machine learning model and/or artificial intelligence model).

The time-series data 204 collected by the receiving LRE corresponds to the performance differences between network A and network B calculated by the receiving LRE 108 at operation (4) described with reference to FIG. 1. For example, the time-series data may include relative latency of network A and network B, absolute latency of network A and network B, packet loss for network A and network B over a given time period, etc. The network telemetry 206 may include the difference in the capacity of network A and network B to transfer data, or the bandwidth of each network, the amount flowing through network A and network B at a given time, localized traffic conditions per network, network hardware differences, network software differences, security measures (e.g., insertions of firewalls, antivirus software, etc.) that may slow down a network, differences in Quality of Service (QOS) settings, etc. The network telemetry 206 may include all or a subset of or even appropriate additional telemetry relating to network A and network B.

By taking in the time-series performance data 204 collected by the receiving LRE and other network telemetry 206 as inputs, the analytics tool 202 can output a predicted performance 208 of redundant networks. For example, the analytics tool may be trained to predict which network is likely to be dominant under certain network conditions. The analytics tool 202 may also predict what the expected latency of frames will be on a given network. The analytics tool may also determine which network to use for load balancing purposes for critical data. Using the predicted variation of performance metrics between the two sides of a HSR/PRP network, a network administrator can plan network changes or diagnose unexpected network problems prior to performance issues occurring.

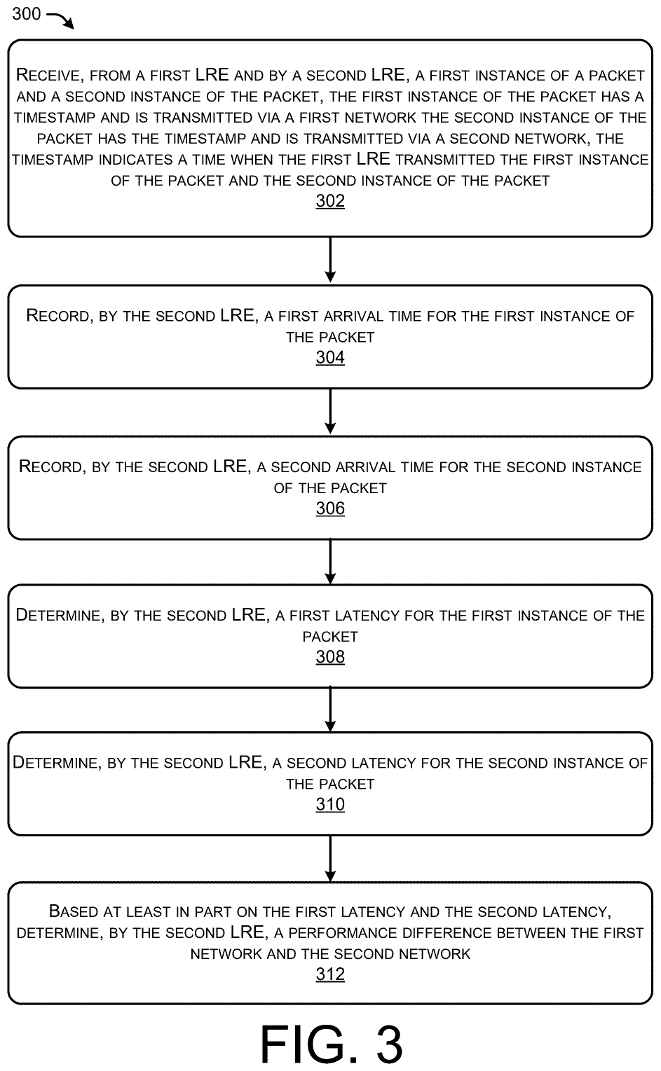

FIG. 3 is a flow diagram illustrating an example method 300 associated with the techniques described herein for configuring network devices to take an action, such as a snapshot capture of the devices state, in response to a trigger event such as an unexpected network event or network error. Example method 300 illustrates aspects of the functions performed by LRE 106 and/or LRE 108 as described with reference to FIG. 1. The logical operations described herein with respect to FIG. 3 may be implemented (1) as a sequence of computer-implemented acts or program modules running on a computing system and/or (2) as interconnected machine logic circuits or circuit modules within the computing system. In some examples, the method(s) 300 may be performed by a system comprising one or more processors and one or more non-transitory computer-readable media storing computer-executable instructions that, when executed by the one or more processors, cause the one or more processors to perform the method(s) 300.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIG. 3 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

At operation 302 from a first LRE, a second LRE receives a first instance of a packet and a second instance of the packet. The first instance of the packet is transmitted via a first network and the second instance of the packet is transmitted via a second network. The first instance of the packet and the second instance of the packet have a timestamp that indicates a time when the first LRE transmitted the first instance of the packet and the second instance of the packet. For example, with reference to FIG. 1 LRE 106 transmits replicate packets, packet 110(A) and packet 110(B) to LRE 108 via redundant networks. Packet 110(A) is transmitted via network A 102 and packet 110(B) is transmitted via network B 104. Packet 110(A) and packet 110(B) are embedded with timestamp T indicating a time when both packets were transmitted via different interfaces of LRE 106 to LRE 108. In a PRP frame, timestamp T may be embedded in an RCT trailer with a sequence number of the ethernet frame. In an HSR frame, timestamp T may be embedded in an HSR tag containing the sequence number of the frame. Alternately, in some examples, packet 110(A) and packet 110(B) may not be embedded with timestamp T.

At operation 304 the second LRE records a first arrival time for the first instance of the packet. For example, with reference to FIG. 1 when LRE 108 receives packet 110(A) that was transmitted via network A 102, LRE 108 records the arrival time.

At operation 306 the second LRE record a second arrival time for the second instance of the packet. For example, with reference to FIG. 1 when LRE 108 receives packet 110(B) that was transmitted via network B 104, LRE 108 records the arrival time. Note in example environment 100 illustrated in FIG. 1 that packet 110(B) arrives at LRE 108 before packet 110(A). Note that in conventional redundant network functioning, when LRE 108 receives a first packet with a particular sequence number, the first packet is processed, when LRE 108 receives a second packet with the same particular sequence number, the second packet is immediately discarded. Using techniques described herein, the second packet with the particular sequence number is not immediately discarded. In contrast, the LRE 108 notes records the arrival time and examines the packet for the timestamp T. Both the specific arrival time and the timestamp T, if present, are noted for further calculation of relative or absolute latency.

At operation 308 the second LRE calculates a first latency for the first instance of the packet. For example, with reference to FIG. 1 LRE 108 calculates a first latency for packet 110(A) using the arrival time recorded for packet 110(A) and the timestamp T embedded in the metadata of packet 110(A).

At operation 310 the second LRE calculates a second latency for the second instance of the packet. For example, with reference to FIG. 1 LRE 108 calculates a second latency for packet 110(B) using the arrival time recorded for packet 110(B) and the timestamp T embedded in the metadata of packet 110(B). Alternately, if packet 110(A) and packet 110(B) do not contain timestamp T, LRE 108 can still calculate relative latency by measuring the time difference of arrival for packet 110(A) and packet 110(B), thus determining a point-in-time performance difference between network A 102 and network B 104.

At operation 312 based at least in part on the first latency and the second latency, the second LRE determines a performance difference between the first network and the second network. For example, with reference to FIG. 1 LRE 108 determines a performance difference between network A 102 and network B 104 based on the latency of each packet, either absolute latency using timestamp T, or relative latency if packet 110(A) and packet 110(B) do not contain embedded timestamp T. Note that in environment 100, packet 110(B) arrives at LRE 108 prior to packet 110(A), thus the latency for packet 110(B) will be less than the latency of packet 110(A). Note, if a first instance of packet 110 is not received by LRE 108 within a predetermined amount of time of a second instance of the packet 110, LRE 108 may determine that the first instance of packet 110 is lost, and thus, accumulate metrics for frame loss for both network A 102 and network B 104. Additionally, once the second LRE, LRE 108, has collected data (e.g., latency, loss, etc.) on packet pairs for each sequence number in a time series, the data may be sent to an analytics tool for additional analysis and network predictions. By predicting the expected latency of frames on a given network, the analysis tool can be used to plan network changes or diagnose unexpected network problems.

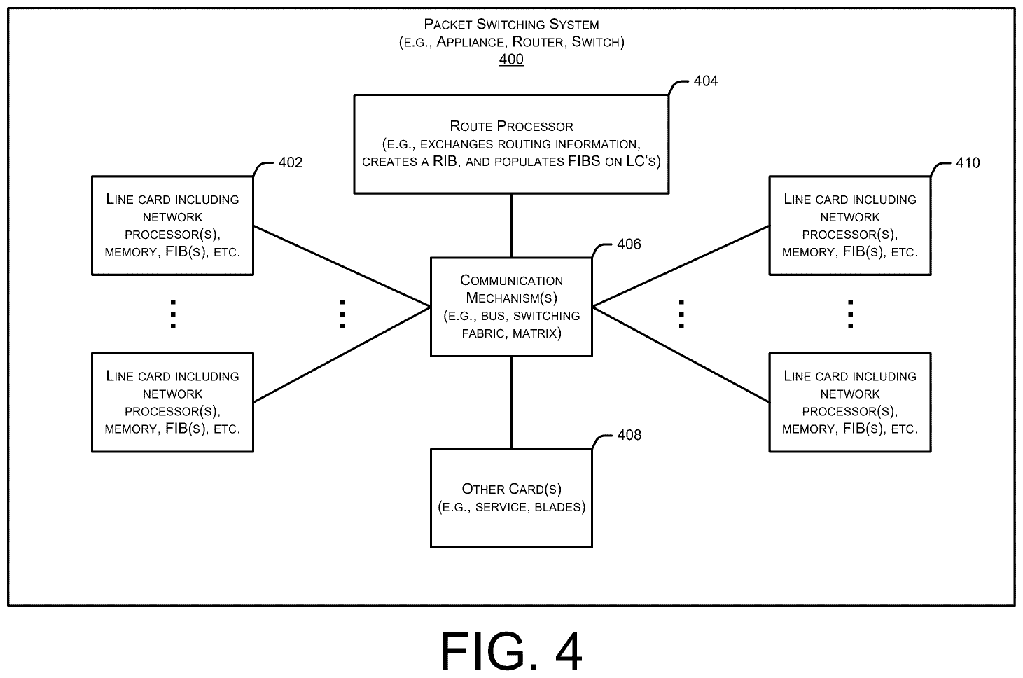

FIG. 4 illustrates a block diagram illustrating an example packet switching device (or system) 400 that can be utilized to implement various aspects of the technologies disclosed herein. In some examples, packet switching device(s) 400 may be employed in various networks, such as, for example, network A 102 or network B 104 described with respect to FIG. 1.

In some examples, a packet switching device 400 may comprise multiple line card(s) 402, 410, each with one or more network interfaces for sending and receiving packets over communications links (e.g., possibly part of a link aggregation group). The packet switching device 400 may also have a control plane with one or more processing elements for managing the control plane and/or control plane processing of packets associated with forwarding of packets in a network. The packet switching device 400 may also include other cards 408 (e.g., service cards, blades) which include processing elements that are used to process (e.g., forward/send, drop, manipulate, change, modify, receive, create, duplicate, apply a service) packets associated with forwarding of packets in a network. The packet switching device 400 may comprise hardware-based communication mechanism 406 (e.g., bus, switching fabric, and/or matrix, etc.) for allowing its different entities, line cards 402, 404, 408 and 410 to communicate. Line card(s) 402, 410 may typically perform the actions of being both an ingress and/or an egress line card 402, 410, in regard to multiple other particular packets and/or packet streams being received by, or sent from, packet switching device 400.

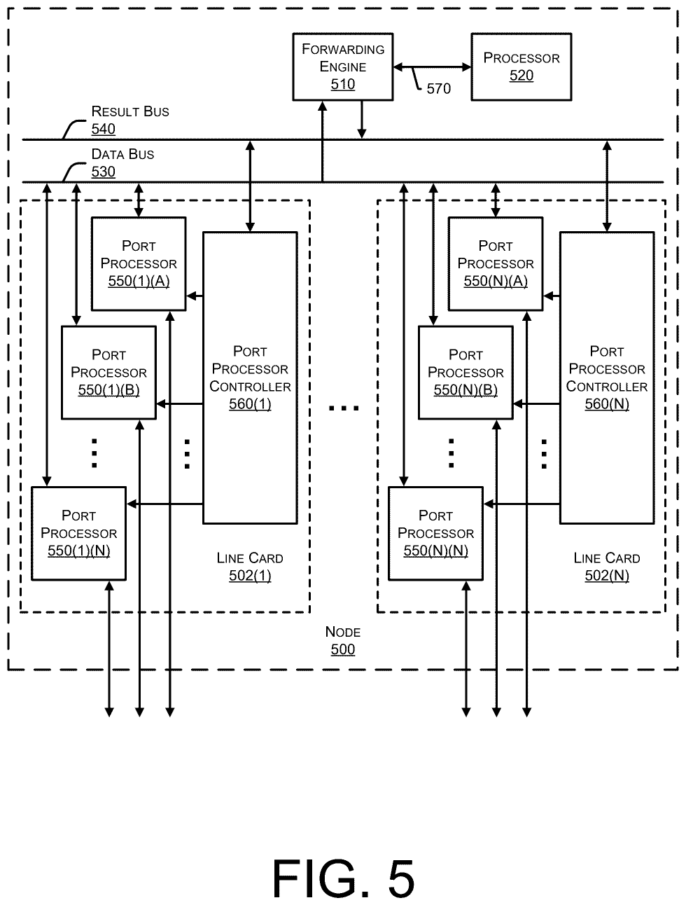

FIG. 5 illustrates a block diagram illustrating certain components of an example node 500 that can be utilized to implement various aspects of the technologies disclosed herein. In some examples, node(s) 500 may be network devices such as network LRE 106 and LRE 108 employed in various networks, such as, for example network A 102 or network B 104 as described with respect to FIG. 1.

In some examples, node 500 may include any number of line cards 502 (e.g., line cards 502(1)-(N), where N may be any integer greater than 1) that are communicatively coupled to a forwarding engine 510 (also referred to as a packet forwarder) and/or a processor 520 via a data bus 530 and/or a result bus 540. Line cards 502(1)-(N) may include any number of port processors 550(1)(A)-(N)(N) which are controlled by port processor controllers 560(1)-(N), where N may be any integer greater than 1. Additionally, or alternatively, forwarding engine 510 and/or processor 520 are not only coupled to one another via the data bus 530 and the result bus 540, but may also communicatively coupled to one another by a communications link 570.

The processors (e.g., the port processor(s) 550 and/or the port processor controller(s) 560) of each line card 502 may be mounted on a single printed circuit board. When a packet or packet and header are received, the packet or packet and header may be identified and analyzed by node 500 (also referred to herein as a router) in the following manner. Upon receipt, a packet (or some or all of its control information) or packet and header may be sent from one of port processor(s) 550(1)(A)-(N)(N) at which the packet or packet and header was received and to one or more of those devices coupled to the data bus 530 (e.g., others of the port processor(s) 550(1)(A)-(N)(N), the forwarding engine 510 and/or the processor 520). Handling of the packet or packet and header may be determined, for example, by the forwarding engine 510. For example, the forwarding engine 510 may determine that the packet or packet and header should be forwarded to one or more of port processors 550(1)(A)-(N)(N). This may be accomplished by indicating to corresponding one(s) of port processor controllers 560(1)-(N) that the copy of the packet or packet and header held in the given one(s) of port processor(s) 550(1)(A)-(N)(N) should be forwarded to the appropriate one of port processor(s) 550(1)(A)-(N)(N). Additionally, or alternatively, once a packet or packet and header has been identified for processing, the forwarding engine 510, the processor 520, and/or the like may be used to process the packet or packet and header in some manner and/or maty add packet security information in order to secure the packet. On a node 500 sourcing such a packet or packet and header, this processing may include, for example, encryption of some or all of the packets or packet and header's information, the addition of a digital signature, and/or some other information and/or processing capable of securing the packet or packet and header. On a node 500 receiving such a processed packet or packet and header, the corresponding process may be performed to recover or validate the packets or packet and header's information that has been secured.

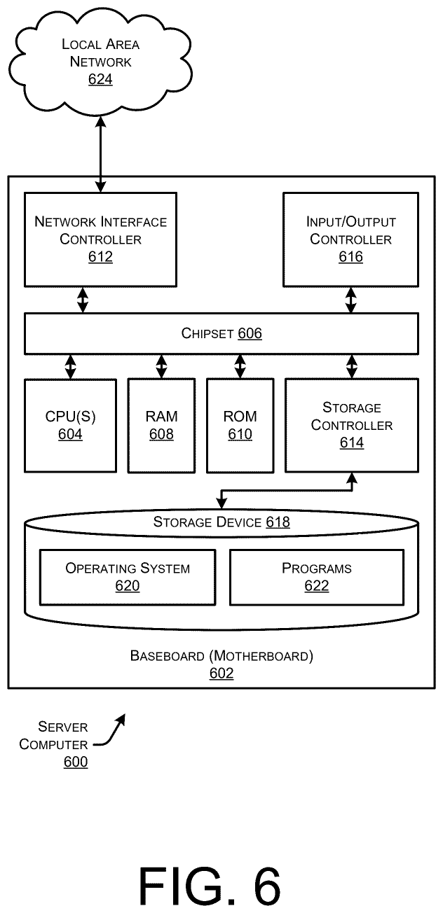

FIG. 6 shows an example computer architecture for a computing device (or network routing device) 600 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The computing device 600 may, in some examples, correspond to a network device such as LRE 106 or LRE 108, the packet switching system 400, and/or the node 500 described herein with respect to FIGS. 1, 4 and 5, respectively.

The computing device 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computing device 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computing device 600. The chipset 606 can further provide an interface to a computer-readable storage medium such as a read-only memory (“ROM”) 610 or non-volatile RAM (“NVRAM”) for storing basic routines that help to startup the computing device 600 and to transfer information between the various components and devices. The ROM 610 or NVRAM can also store other software components necessary for the operation of the computing device 600 in accordance with the configurations described herein.

The computing device 600 can operate in a networked environment using logical connections to remote computing devices and computer systems through a network, such as the network 624. Network 624 may, in some examples, correspond to network A 102 or network B 104 of FIG. 1. The chipset 606 can include functionality for providing network connectivity through a NIC 612, such as a gigabit Ethernet adapter. The NIC 612 is capable of connecting the computing device 600 to other computing devices over the network 624. It should be appreciated that multiple NICs 612 can be present in the computing device 600, connecting the computer to other types of networks and remote computer systems.

The computing device 600 can be connected to a storage device 618 that provides non-volatile storage for the computing device 600. The storage device 618 can store an operating system 620, programs 622, and data, which have been described in greater detail herein. The storage device 618 can be connected to the computing device 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computing device 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 can further read information from the storage device 618 by detecting the physical states or characteristics of one or more particular locations within the physical storage units.

In addition to the mass storage device 618 described above, the computing device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 600. In some examples, the operations performed by LRE 106 or LRE 108, and/or any components included therein, may be supported by one or more devices similar to computing device 600. Stated otherwise, some or all of the operations performed by LRE 106 or LRE 108, or any components included therein, may be performed by one or more computing device 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computing device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computing device 600.

In one embodiment, the storage device 618 or other computer-readable storage media is encoded with computer-executable instructions which, when loaded into the computing device 600, transform the computer from a general-purpose computing system into a special-purpose computer capable of implementing the embodiments described herein. These computer-executable instructions transform the computing device 600 by specifying how the CPUs 604 transition between states, as described above. According to one embodiment, the computing device 600 has access to computer-readable storage media storing computer-executable instructions which, when executed by the computing device 600, perform the various processes described above with regard to FIG. 6. The computing device 600 can also include computer-readable storage media having instructions stored thereupon for performing any of the other computer-implemented operations described herein.

The computing device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computing device 600 might not include all of the components shown in FIG. 6, can include other components that are not explicitly shown in FIG. 6, or might utilize an architecture completely different than that shown in FIG. 6.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, from a first link redundancy entity (LRE) and by a second LRE, a first instance of a packet and a second instance of the packet, the first instance of the packet having a timestamp and transmitted via a first network, the second instance of the packet having the timestamp and transmitted via a second network, wherein the timestamp indicates a time when the first LRE transmitted the first instance of the packet and the second instance of the packet;
recording, by the second LRE, a first arrival time for the first instance of the packet;
recording, by the second LRE, a second arrival time for the second instance of the packet;
determining, by the second LRE, a first latency for the first instance of the packet;
determining, by the second LRE, a second latency for the second instance of the packet; and
based at least in part on the first latency and the second latency, determining, by the second LRE, a performance difference between the first network and the second network.

2. The method of claim 1, wherein the timestamp is added to a parallel redundancy protocol (PRP) header or a high-availability seamless redundancy (HSR) tag of the first instance of the packet and the second instance of the packet.

3. The method of claim 1, further comprising:
determining, by the second LRE, that the first instance of the packet is lost if the first instance of the packet is not received within a predetermined amount of time of the second instance of the packet; and
determining metrics for packet loss for the first network.

4. The method of claim 1, further comprising transmitting, by the second LRE, the first latency and the second latency to an analytics tool.

5. The method of claim 4, wherein the analytics tool is a cloud-based service, on-prem at a customer, or localized within the second LRE as an edge application.

6. The method of claim 4, wherein the analytics tool utilizes the first latency, the second latency, and other telemetry data including bandwidth, network traffic data, network hardware differences, and network software differences to analyze the first network and the second network.

7. The method of claim 1, wherein the second LRE collects data on frame pairs for each sequence number in a time series.

8. A system comprising:
one or more processors; and
one or more computer-readable media storing computer-executable instructions that, when executed by the one or more processors, cause the one or more processors to perform operations comprising:
receiving, from a first link redundancy entity (LRE) and by a second LRE, a first instance of a packet and a second instance of the packet, the first instance of the packet having a timestamp and transmitted via a first network, the second instance of the packet having the timestamp and transmitted via a second network, wherein the timestamp indicates a time when the first LRE transmitted the first instance of the packet and the second instance of the packet;
recording, by the second LRE, a first arrival time for the first instance of the packet;
recording, by the second LRE, a second arrival time for the second instance of the packet;
determining, by the second LRE, a first latency for the first instance of the packet;
determining, by the second LRE, a second latency for the second instance of the packet; and
based at least in part on the first latency and the second latency, determining, by the second LRE, a performance difference between the first network and the second network.

9. The system of claim 8, wherein the timestamp is added to a parallel redundancy protocol (PRP) header or a high-availability seamless redundancy (HSR) tag of the first instance of the packet and the second instance of the packet.

10. The system of claim 8, the operations further comprising:
determining, by the second LRE, that the first instance of the packet is lost if the first instance of the packet is not received within a predetermined amount of time of the second instance of the packet; and
determining metrics for packet loss for the first network.

11. The system of claim 8, the operations further comprising transmitting, by the second LRE, the first latency and the second latency to an analytics tool.

12. The system of claim 11, wherein the analytics tool is a cloud-based service, on-prem at a customer, or localized within the second LRE as an edge application.

13. The system of claim 11, wherein the analytics tool utilizes the first latency, the second latency, and other telemetry data including bandwidth, network traffic data, network hardware differences, and network software differences to analyze the first network and the second network.

14. The system of claim 8, wherein the second LRE collects data on frame pairs for each sequence number in a time series.

15. One or more non-transitory computer-readable media storing instructions that, when executed, cause one or more processors to perform operations comprising:
receiving, from a first link redundancy entity (LRE) and by a second LRE, a first instance of a packet and a second instance of the packet, the first instance of the packet having a timestamp and transmitted via a first network, the second instance of the packet having the timestamp and transmitted via a second network, wherein the timestamp indicates a time when the first LRE transmitted the first instance of the packet and the second instance of the packet;
recording, by the second LRE, a first arrival time for the first instance of the packet;
recording, by the second LRE, a second arrival time for the second instance of the packet;
determining, by the second LRE, a first latency for the first instance of the packet;
determining, by the second LRE, a second latency for the second instance of the packet; and
based at least in part on the first latency and the second latency, determining, by the second LRE, a performance difference between the first network and the second network.

16. The one or more non-transitory computer-readable media of claim 15, wherein the timestamp is added to a parallel redundancy protocol (PRP) header or a high-availability seamless redundancy (HSR) tag of the first instance of the packet and the second instance of the packet.

17. The one or more non-transitory computer-readable media of claim 15, the operations further comprising:
determining, by the second LRE, that the first instance of the packet is lost if the first instance of the packet is not received within a predetermined amount of time of the second instance of the packet; and
determining metrics for packet loss for the first network.

18. The one or more non-transitory computer-readable media of claim 15, the operations further comprising transmitting, by the second LRE, the first latency and the second latency to an analytics tool.

19. The one or more non-transitory computer-readable media of claim 18, wherein the analytics tool is a cloud-based service, on-prem at a customer, or localized within the second LRE as an edge application.

20. The one or more non-transitory computer-readable media of claim 18, wherein the analytics tool utilizes the first latency, the second latency, and other telemetry data including bandwidth, network traffic data, network hardware differences, and network software differences to analyze the first network and the second network.
